(19) United States
(12) Patent Application Publication
(10) Pub. No.: US 2006/0272610 A1
(43) Pub. Date: Dec. 7, 2006

(54) Rotary heat engine

(76) Inventor: Ronald Francis Murawsky, Clearwater, FL (US)

Correspondence Address: RONALD FRANCIS MURAWSKY, 2320 HAWTHORHNE DRIVE, CLEAR WATER, FL, 33763-1511, US

(21) Appl. No.: 11/299,291

(22) Filed: Dec. 12, 2005

Related U.S. Application Data
(63) Continuation of application No. 10/921,618, filed on Aug. 20, 2004.

(51) Int. Cl. F02B 53/00; F01C 9/00; F01C 1/07; F01C 1/00

(52) U.S. Cl. 123/241; 123/245; 123/223; 123/18 A; 123/18 R; 418/35; 418/36; 418/37; 418/38

(57) ABSTRACT

A rotary internal combustion engine with two opposing rotary discs, each having a half-cylindrical chamber located around its perimeter. An outer casing encompasses both rotary discs. Intake and exhaust ports and necessary engine controls are formed in said outer casing. Pistons formed in each said disc. Half of said piston is connected permanently to one said rotary disc the other half of said piston slides in the half cylindrical chamber of the opposing said rotary disc. The pistons and cylindrical chambers develop varying volumes in each chamber, depending on the position of each disc and respective piston. These varying volumes perform different cycles common to four stroke piston engines. Mechanical devises allow the discs to rotate in only one direction. Mechanical devises allow the disc to engage output shaft in only one direction. From output shaft work can be derived.

This application is a continuation of the application having a application Ser. No. 10/921,618 filed on Aug. 20, 2004.

### CROSS-REFERENCE TO RELATED APPLICATIONS

None

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

### Field of the Invention

This invention relates to enclosed chamber rotary heat engines.

### BRIEF SUMMARY OF THE INVENTION.

This invention performs all the necessary functions common to the internal combustion piston engine but its inherent design eliminates the main draw backs associated with a reciprocating piston engine. Fore instance, the main moving parts rotate, which maintains less stress on internal parts and less energy required to stop and start a piston moving on a linear path. Also the torque developed during the power stroke of this invention is greater because the force on the momentum arm remains perpendicular for the duration of the power stroke and the length of the momentum remains at its maximum for the duration of the power stroke.

### BRIEF DESCRIPTION OF THE SEVERAL VIEWS OR THE DRAWINGS

FIG. 1 is a sectional view of a rotary disc;

FIG. 2 is a top view of a rotary disc;

FIG. 3 is sectional view of rotary disc;

FIG. 4 is a top view of rotary disc;

FIG. 5 is a sectional view of rotary disc;

FIG. 6 is a top view of rotary disc;

FIG. 7 is a sectional view of the exterior casing;

FIG. 8 is a top view of the exterior casing;

FIG. 9 is a sectional view of the exterior casing;

FIG. 10 is a top view of the exterior casing;

FIG. 11 is a front view of the output shaft;

FIG. 12 is a top view of the output shaft;

FIG. 13 is a composite sectional view of the complete engine;

FIG. 14-17 skeletal drawing depicting the inner functions;

Described in its running phase:

FIG. 14.

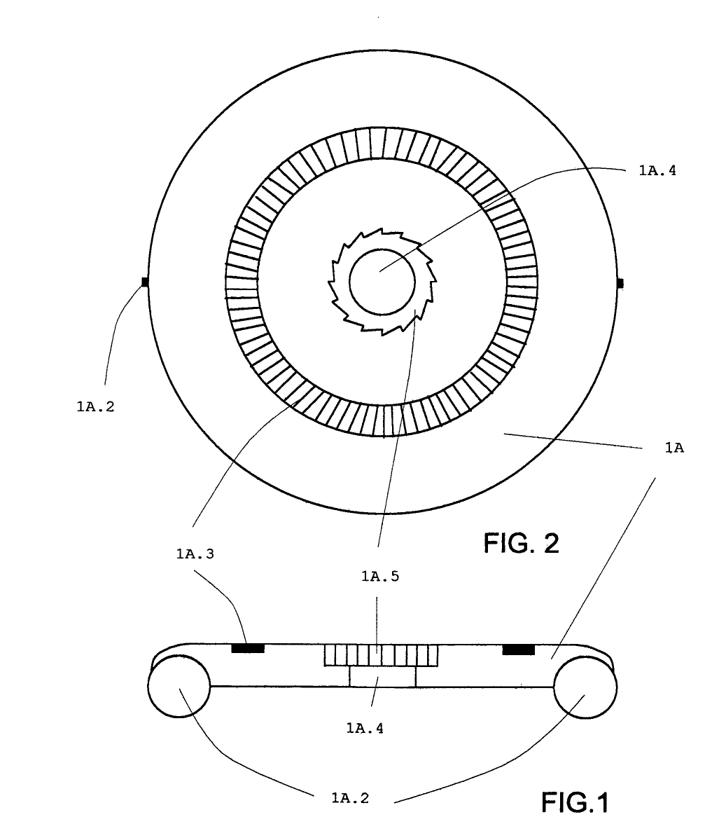

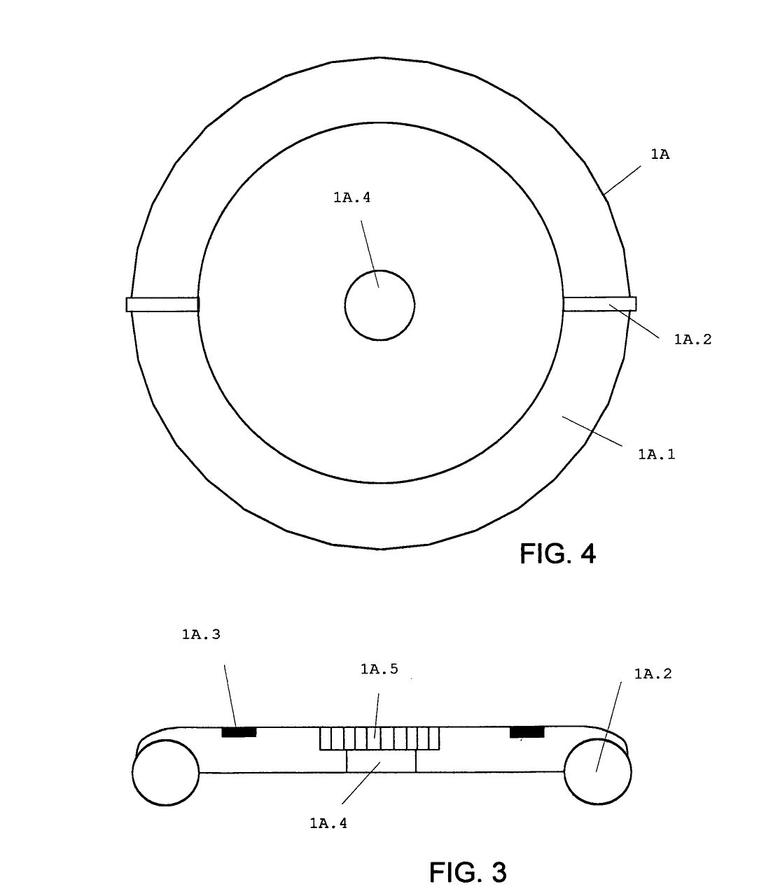

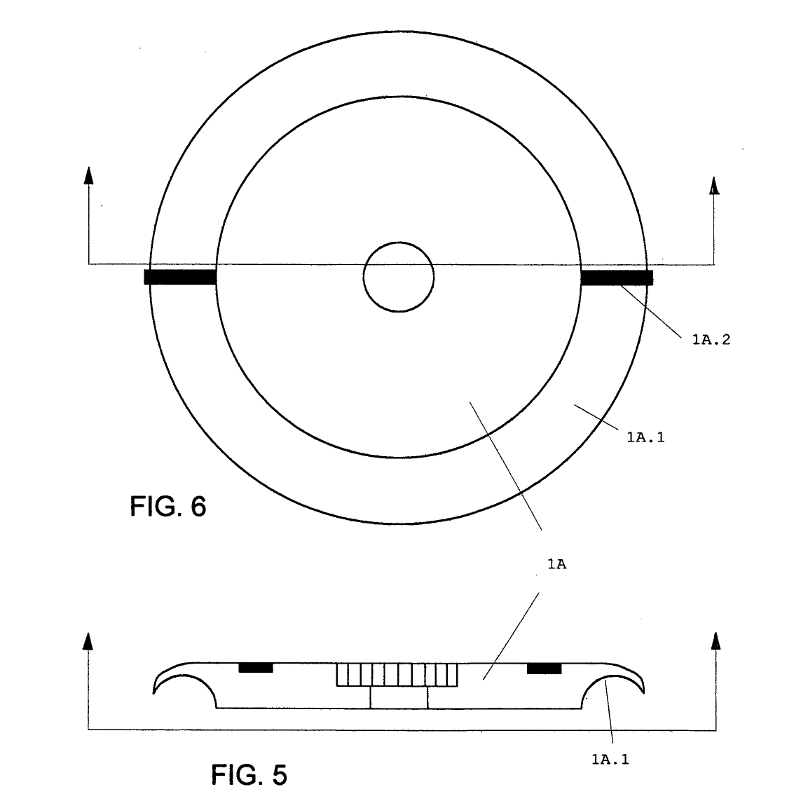

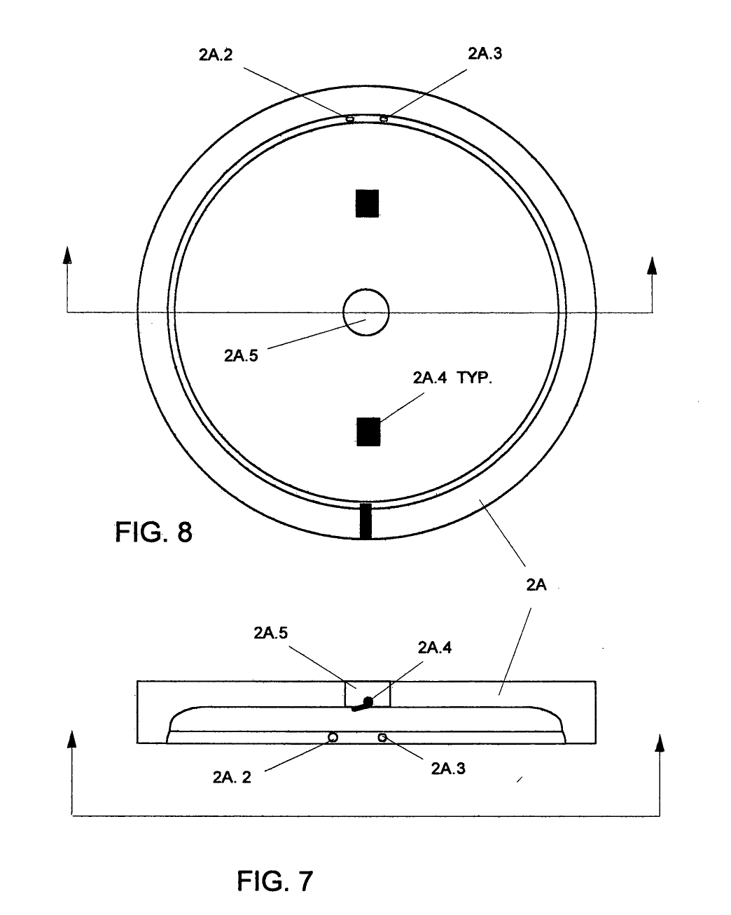

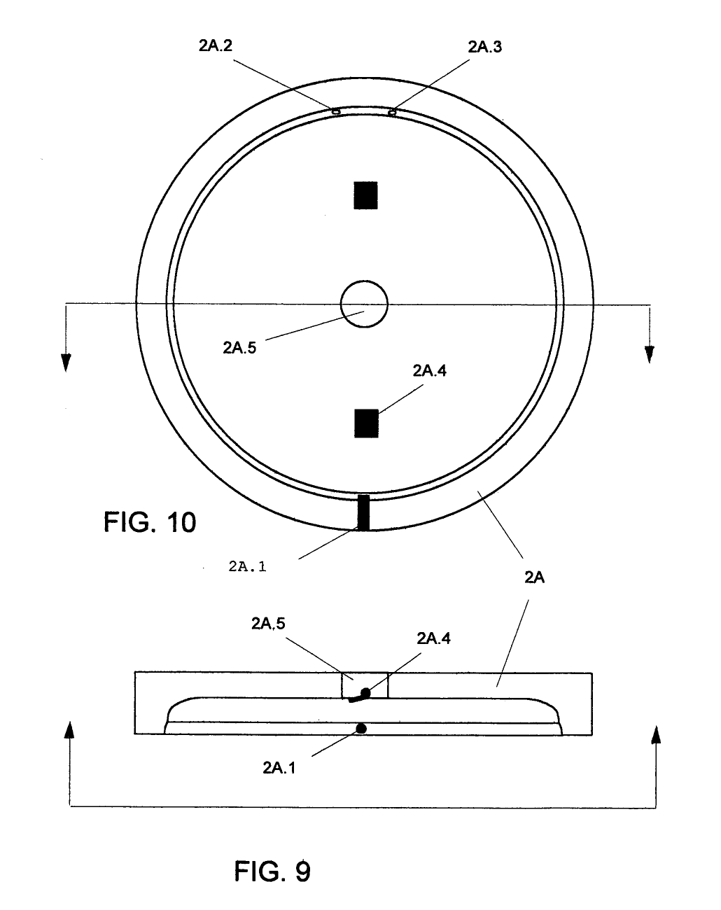

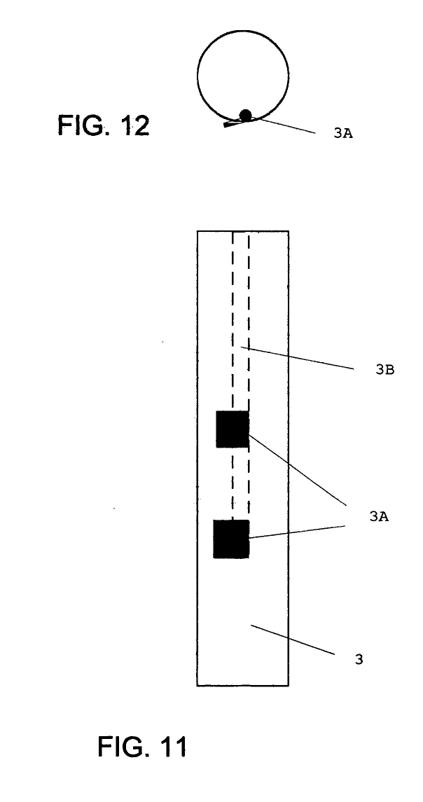

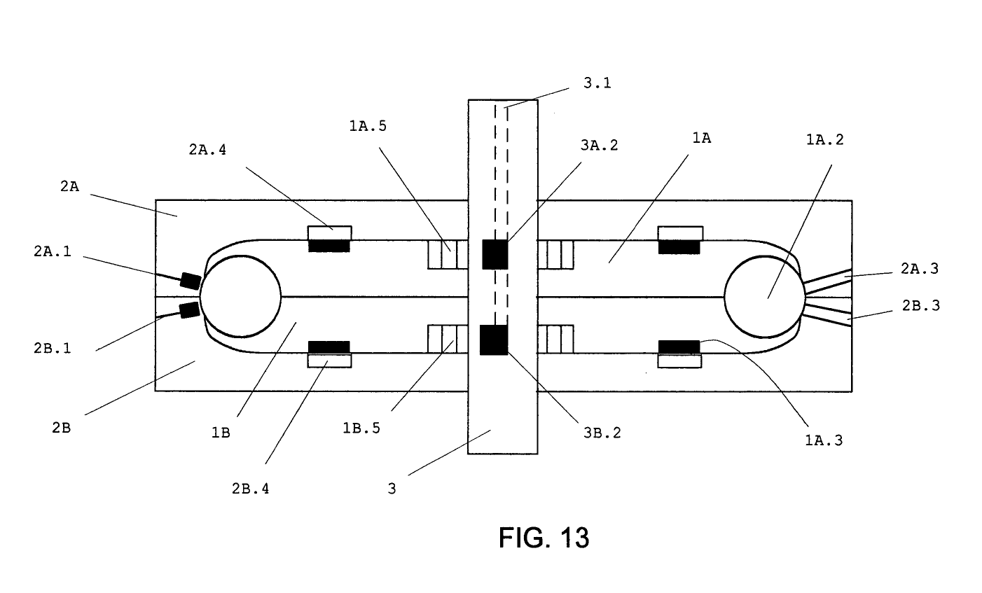

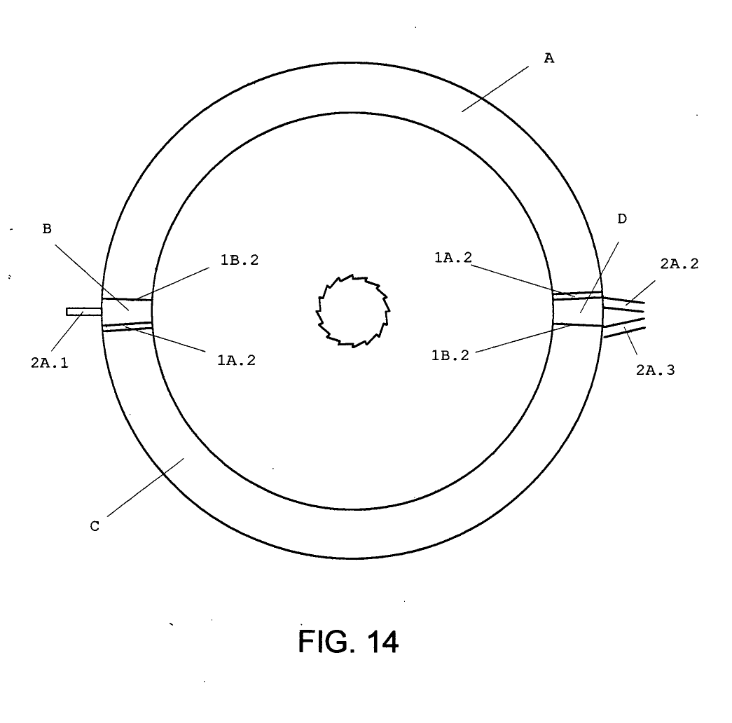

Chamber A—Combustion able fluid is drawn in Intake Port 2A.2.

Chamber B—The momentum from rotating Disc 1B.2 is transfer to stationary Disc 1A.2 setting Disc 1A.2 into rotation. A spark is produced by a Spark Plug 2A.1 Combustion occurs increasing pressure and heat. Disc 1A.2 begins to rotate counter clockwise.

Chamber C—Heat and pressure are applying force to Disc 1B.2. The pressure in Chamber B and Chamber C is the same.

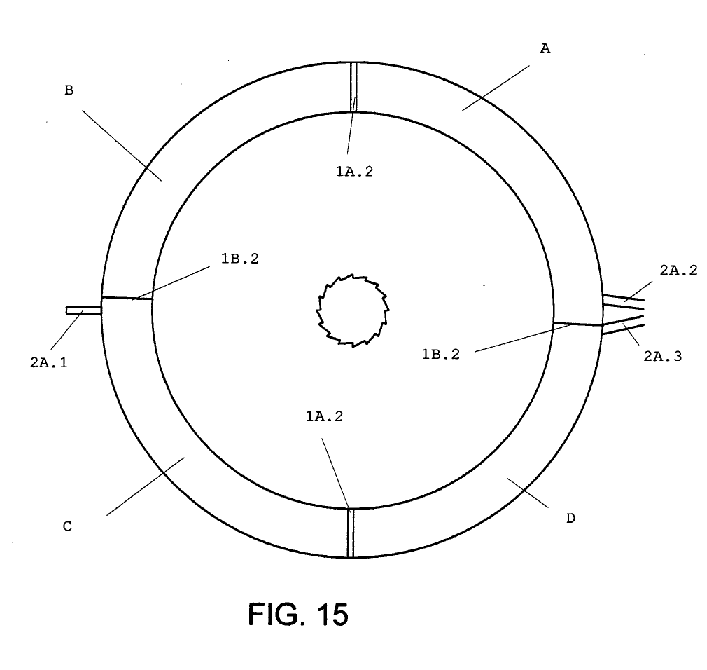

Chamber D—Spent fuel is exhausted out Exhaust Port 2A.3. FIG. 15.

Chamber A—Fluid is drawn in Intake Port 2A.2.

Chamber B—Fluid is compressed.

Chamber C—The force from combustion is rotating Disc 1A.2.

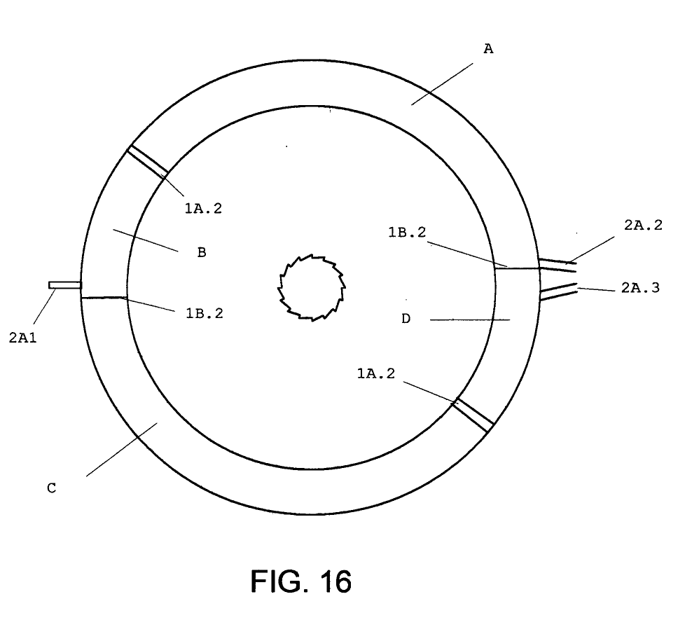

Chamber D—Force from non exhausted spent fuel is applied to Disc 1B.2. FIG. 16.

Chamber A—Fluid is drawn in Intake Port 2A.2.

Chamber B—Fluid is compressed.

Chamber C—The force from combustion is rotating Disc 1A.2.

Chamber D—Disc 1B.2 has just rotated slightly counter clockwise allowing spent exhaust gases to escape through Exhaust Port 2A.6.

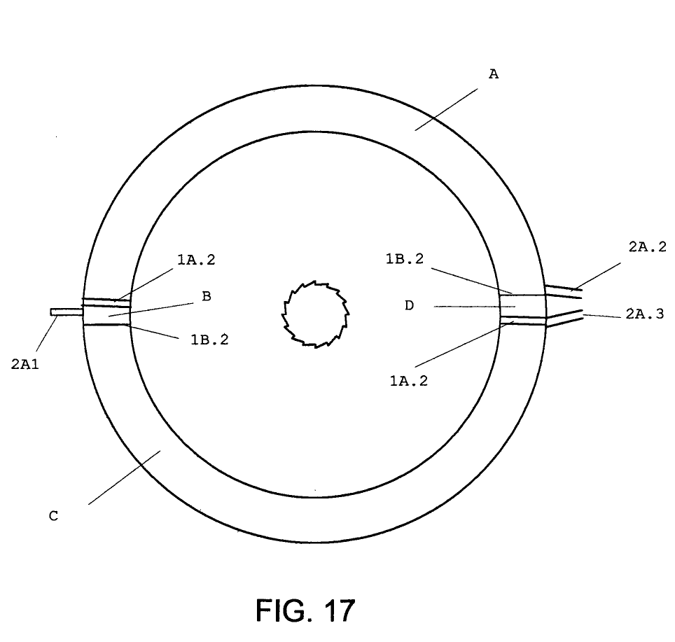

FIG. 17. The cycle now repeats itself.

### DETAILED DESCRIPTION OF THE INVENTION

This invention relates to an internal combustion rotary engine that converts thermal energy into mechanical energy. Comprising of two opposing rotary discs 1A, 1B. Each formed with a half cylindrical chamber 1A.1, 1B.1 located around its perimeter. Located in chamber 1A.1, 1B.1 two perimeter pistons 1A.2, 1B.2 located approximately 180 degrees apart from each other. Approximately half of each piston 1A.2, 1B.2 is attached permanently to one rotary disc and the other half slides inside the chamber of the opposing rotary disc 1A and 1B respectively. Air gape between said piston and opposing rotary disc is minimized to prevent the passage of fluid. Output shaft hole 1A.4, 1B.4 is located in the center of rotary disc 1A, 1B. Output shaft 3 passes through concentric output shaft hole 1A.4, 1B.4. The center outer side of rotary disc 1A, 1B is located output shaft 3 ratcheting teeth 1A.5, 1B.5

Exterior casing 2A, 2B is formed to fit the exterior of rotary disc 1A, 1B. At least one spark plug 2A.1, 2B.1 is form to the exterior of casing 2A, 2B. At least one intake port 2A.2, 2B.2 is formed approximately 180 degrees from spark plug 2A.1, 2B.1. At least one exhaust port 2A.3, 2B.3 is formed approximately 180 degrees from spark plug 2A.1, 2B.1. A circle of ratcheting teeth 1A.3, 1B.3 is formed on the exterior of rotary disc 1A, 1B. At least one ratcheting lever 2A.4, 2B.4 is aligned with ratcheting teeth 1A.3, 1B.3. Ratcheting teeth 1A.3, 1B.3 combining with ratcheting lever 2A.4, 2B.4 will allow rotary disc 1A, 1B to rotate in only one direction. Output shaft 3 passes through concentric output shaft hole 2A.5, 2B.5.

Output shaft 3 fits inside hole 1A.4, 1B.4, 2A.5, and 2B.5. Output shaft 3 incorporates at least one ratcheting lever 3A.2, 3B.2. Ratcheting lever 3A.2, 3B.2 is aligned and works in conjunction with ratcheting teeth 1A.5, 1B5. This will allow rotary discs 1A, 1B to engage output shaft 3 while rotating in only one direction.

Spark plug 2A.1, 2A.1 ignites fluid mixture which causes combustion. Force is applied to pistons 1A.2, 1B.2, this force will cause rotary disc 1A, 1B to rotate. Connected to rotary disc 1A, 1B is output shaft 3 from which work can be derived. Fluid mixture may also be ignited by the heat of compression commonly know as dieseling. This would eliminate the need of a spark plug.

1. An enclosed chamber internal combustion engine comprises:
two rotary discs being opposite and having at least one half-cylindrical chamber located around the perimeter of said two rotary discs;
at least one piston located in each of said at least one half cylindrical chamber;
wherein half of each said piston is attached permanently to one of said two rotary discs and the other half of said at least one piston is formed to fit inside the opposing said rotary disc;
wherein a section of the said piston which is not permanently fixed to said rotary disc slides in the said half cylindrical chamber of the opposing said rotary disc;
sealing means provided by a minimizing air gape in areas of said rotary disc and said at least one piston preventing fluid leakage;
an exterior casing formed to fit an exterior of said two rotary discs further comprising:
at least one intake port;
at least one exhaust port; and
at least one spark plug;
ratcheting teeth;
at least one ratcheting lever;
an output shaft; and
a concentric output shaft hole being at center of said two rotary discs;
wherein said output shaft and said two rotary discs are engaged with said ratcheting teeth and said at least one ratcheting lever to allow said output shaft rotating said rotary disc rotating in only one direction
